(19) United States
(12) Patent Application Publication
(10) Pub. No.: US 2008/0291895 A1
(43) Pub. Date: Nov. 27, 2008

(54) Integrated access device, voice over internet protocol system and backup method thereof

(75) Inventor: Ching-Chieh Huang, Taoyuan (TW)

Correspondence Address: BACON & THOMAS, PLLC, 625 SLATERS LANE, FOURTH FLOOR, ALEXANDRIA, VA, 22314-1176, US

(73) Assignee: Arcadyan Technology Corporation, Hsinchu (TW)

(21) Appl. No.: 11/802,285

(22) Filed: May 22, 2007

(51) Int. Cl. H04L 12/66

(52) U.S. Cl. 370/352

(57) ABSTRACT

An integrated access device, a voice over Internet protocol (VOIP) system and a backup method thereof. The VOIP system includes a first remote server, a second remote server and an integrated access device. The integrated access device includes a first Internet protocol interface, a second Internet protocol interface, a memory unit and a processing unit. A first network connection is built between the first Internet protocol interface and the first remote server, and a second network connection is built between the second Internet protocol interface and the second remote server. The memory unit is for storing a program, and the processing unit executes the program to judge whether a voice packet in the integrated access device can be transmitted through the first network connection or not. When the voice packet cannot be transmitted through the first network connection, the voice packet will be timely transmitted through the second network connection.

### BACKGROUND OF THE INVENTION

1. Field of the Invention

The invention relates in general to an integrated access device, a voice over Internet protocol (VOIP) system and a backup method, and more particularly to an integrated access device having a backup function, a VOIP system and a backup method thereof.

2. Description of the Related Art

A conventional phone utilizes an analog transmission method and builds a private line talking channel between two sides through a public switched telephone network (PSTN).

With the popularization of the Internet, a voice over Internet protocol (VOIP) has been developed. The VOIP relates to the technology of transmitting the analog voice over the Internet protocol (IP) network. A voice packet is outputted to a target end in a digital manner over the IP network after a series of acoustoelectric converting, quantitative sampling, encoding, packaging, compressing, de-jittering have been processed. Then, the voice may be reproduced for the receiver after the inverse procedures are performed.

The VOIP enables the voice application product to communicate with a phone through the IP network (e.g., Internet). The technology includes protocols, software-hardware standards and computer programs. Many phone products and desktop voice talking services adopt the VOIP. The VOIP has become the important technology and is widely spread over the public culture.

FIG. 1 (PriorArt) is a schematic illustration showing a conventional VOIP system 100. Referring to FIG. 1, the conventional VOIP system 100 includes a communication end device 110, an integrated access device (IAD) 120 and a multi-service broadband remote access server (MS-BRAS) 130.

The communication end device 110 is, for example, a VOIP phone. The communication end device 110 is connected to the IAD 120 having a multi-service Internet protocol interface 122 in a wireless manner or a wired manner.

The MS-BRAS 130 is disposed in an Internet service provider (ISP), and a multi-service network connection 160 is built between the multi-service Internet protocol interface 122 and the MS-BRAS 130. The user can transmit data, images or voice over the Internet through the multi-service network connection 160, and can make a VOIP phone call through the multi-service network connection 160.

For example, when the user makes the VOIP phone call through the communication end device 110, the voice packet is transmitted to a network 150 through the IAD 120, the multi-service network connection 160, and the MS-BRAS 130.

However, if other users are transmitting the data, the images or the voice through the multi-service network connection 160, the delay time of the voice packet transmission is lengthened, thereby influencing the talking quality of the VOIP phone seriously. Furthermore, when the multi-service network connection 160 is abnormal, the IAD 120 cannot transmit the voice packet smoothly through the multi-service network connection 160. Thus, the talking may be interrupted or the VOIP phone call cannot be made, and the talking quality of the VOIP phone is seriously influenced.

### SUMMARY OF THE INVENTION

The invention is directed to an integrated access device, a VOIP system and a backup method thereof, in which a voice packet may be timely transmitted through another network connection when the voice packet cannot be normally transmitted through an original network connection. Thus, the better talking quality can be provided for the user by effectively avoiding the talking interruption and the incapability of making a VOIP phone call.

According to a first aspect of the present invention, a VOIP system is provided. The VOIP system includes a first remote server, a second remote server and an integrated access device. The integrated access device includes a first Internet protocol interface, a second Internet protocol interface, a memory unit and a processing unit. A first network connection is built between the first Internet protocol interface and the first remote server, and a second network connection is built between the second Internet protocol interface and the second remote server. The memory unit stores a program, and the processing unit executes the program to judge whether the integrated access device can transmit a voice packet through the first network connection or not. When the integrated access device cannot transmit the voice packet through the first network connection, the voice packet is timely transmitted through the second network connection.

According to a second aspect of the present invention, an integrated access device is provided. The integrated access device includes a first Internet protocol interface, a second Internet protocol interface, a memory unit and a processing unit. A first network connection is built between the first Internet protocol interface and a first remote server, and a second network connection is built between the second Internet protocol interface and a second remote server. The memory unit stores a program, and the processing unit executes the program to judge whether the integrated access device can transmit a voice packet through the first network connection or not. When the integrated access device cannot transmit the voice packet through the first network connection, the voice packet is timely transmitted through the second network connection.

According to a third aspect of the present invention, a backup method of a VOIP system is provided. The VOIP system includes a first remote server, a second remote server and an integrated access device. The integrated access device includes a first Internet protocol interface and a second Internet protocol interface. A first network connection is built between the first Internet protocol interface and the first remote server, and a second network connection is built between the second Internet protocol interface and the second remote server. The backup method includes the steps of: judging whether the integrated access device transmits a voice packet through the first network connection or not; and enabling the integrated access device to enter a backup mode so that the voice packet is timely transmitted through the second network connection if the integrated access device does not transmit the voice packet through the first network connection.

The invention will become apparent from the following detailed description of the preferred but non-limiting embodiments. The following description is made with reference to the accompanying drawings.

### BRIEF DESCRIPTION OF THE DRAWINGS

FIG. 1 (PriorArt) is a schematic illustration showing a conventional VOIP system.

FIG. 2 is a schematic illustration showing a VOIP system according to a preferred embodiment of the invention.

FIG. 3 is a flow chart showing a backup method of the VOIP system according to the preferred embodiment of the invention.

FIG. 4 is a detailed flow chart showing the step 310.

FIG. 5 is a detailed flow chart showing the step 320.

FIG. 6 is a detailed flow chart showing the step 330.

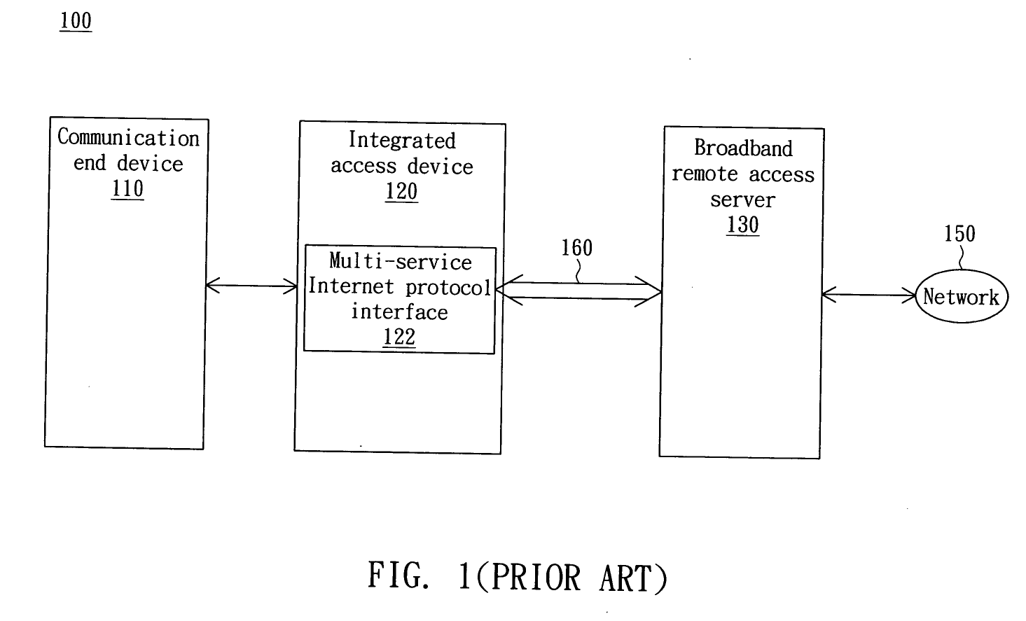

### DETAILED DESCRIPTION OF THE INVENTION

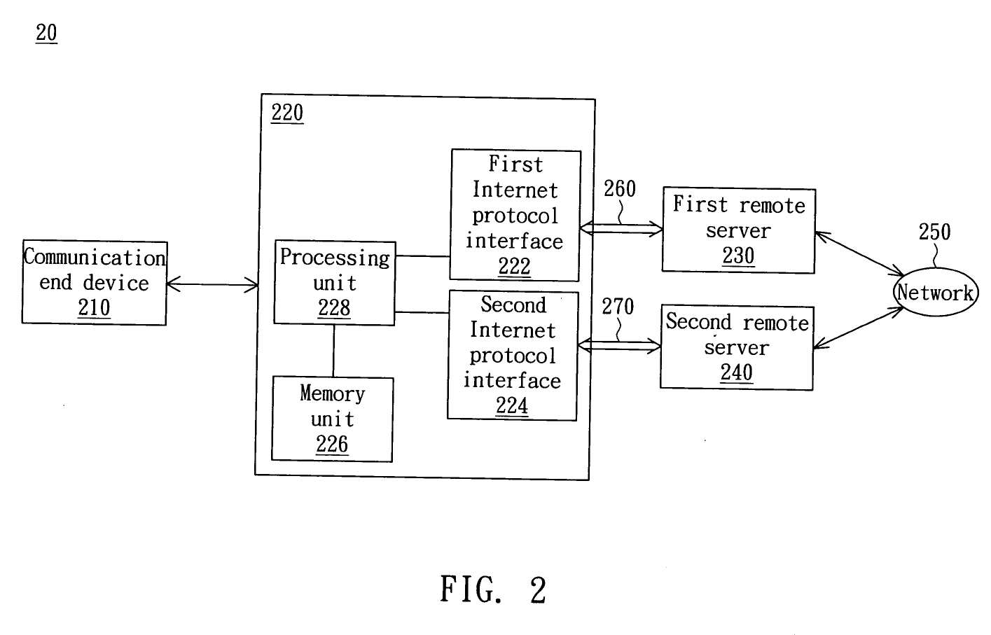

FIG. 2 is a schematic illustration showing a VOIP system 20 according to a preferred embodiment of the invention. Referring to FIG. 2, the VOIP system 20 includes a communication end device 210, an integrated access device (IAD) 220, a first remote server 230 and a second remote server 240.

The first remote server 230 and the second remote server 240 are disposed in an Internet service provider (ISP), and the first remote server 230 and the second remote server 240 may be a voice broadband remote access server (Voice-BRAS) and a multi-service broadband remote access server (MS-BRAS).

The communication end device 210 is, for example, a VOIP phone, and is connected to the IAD 220 in a wireless or wired manner, for example.

The IAD 220 includes a first Internet protocol interface 222, a second Internet protocol interface 224, a memory unit 226 and a processing unit 228.

The first Internet protocol interface 222 and the second Internet protocol interface 224 are respectively a voice Internet protocol interface and a multi-service Internet protocol interface, for example. A first network connection 260 and a second network connection 270 are respectively built between the first Internet protocol interface 222 and the first remote server 230 and between the second Internet protocol interface 224 and the second remote server 240.

The first network connection 260 is dedicated to the transmission of the voice packet in order to shorten the delay time of the voice packet transmission. The user can transmit data, images or voice over the Internet through the second network connection 270. If the first network connection 260 becomes abnormal, the second network connection 270 timely serves as a backup line for the first network connection 260 so as to prevent the talking from being interrupted or prevent the VOIP phone call from being made unsmoothly. Thus, the better talking quality can be provided for the user.

The-memory unit 226 of the IAD 220 stores a program, and the processing unit 228 executes this program to judge whether the IAD 220 can normally transmit the voice packet through the first network connection 260 or not. When the voice packet cannot be normally transmitted through the first network connection 260, the IAD 220 timely transmits the voice packet through the second network connection so as to ensure the normal talking quality.

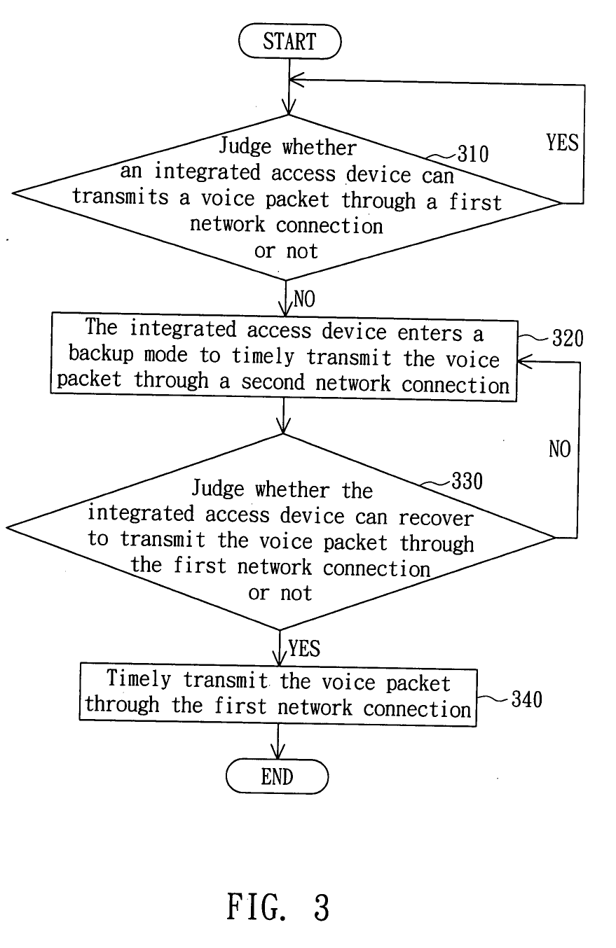

FIG. 3 is a flow chart showing a backup method of the VOIP system according to a preferred embodiment of the invention. Referring to FIG. 3, the backup method is applied to the VOIP system 20 and includes the following steps.

First, as shown in step 310, the processing unit 228 executes the program to judge whether the IAD 220 can transmit the voice packet through the first network connection 260 or not. If it is judged that the IAD 220 can transmit the voice packet through the first network connection 260, the IAD 220 can transmit the voice packet through the first network connection 260. Because the first network connection 260 is dedicated to the transmission of the voice packet, the delay time of the voice packet transmission can be shortened.

Next, as shown in step 320, if the IAD 220 cannot transmit the voice packet through the first network connection 260, the IAD 220 enters a backup mode to timely transmit the voice packet through the second network connection 270. Because the second network connection 270 can timely serve as the backup line of the first network connection 260, it is possible to effectively prevent the talking from being interrupted or prevent the VOIP phone call from being made unsmoothly, thereby providing the better talking quality for the user.

Then, as shown in step 330, after the voice packet is transmitted through the second network connection 270, the processing unit 228 executes the program to judge whether the IAD 220 can recover to transmit the voice packet through the first network connection 260 or not. If it is judged that the IAD 220 can't recover to transmit the voice packet through the first network connection 260, the step 320 is performed.

Finally, as shown in step 340, if it is judged that the IAD 220 can recover to transmit the voice packet through the first network connection 260, the voice packet is timely transmitted through the first network connection 260. if it is judged that the IAD 220 can not recover to transmit the voice packet through the first network connection 260, the IAD 220 still keep in the backup mode to timely transmit the voice packet through the second network connection 270.

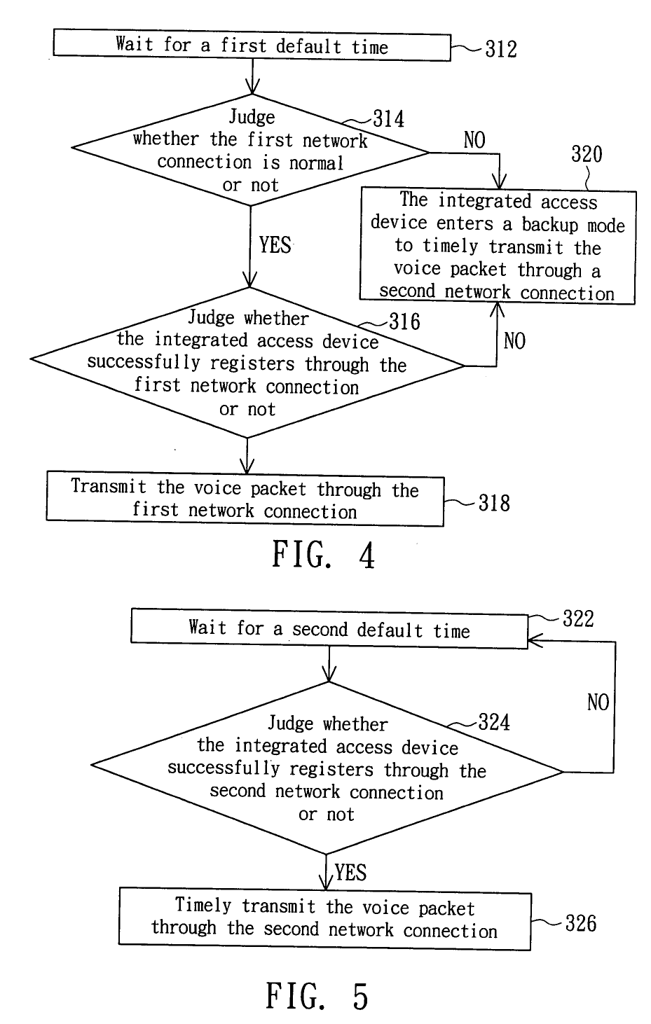

FIG. 4 is a detailed flow chart showing the step 310. Referring to FIG. 4, the step 310 includes the following steps. First, as shown in step 312, a first default time, such as 60 seconds, is waited for.

Next, as shown in step 314, after the first default time has elapsed, the processing unit 228 executes the program to judge whether the first network connection 260 is normal or not. If the first network connection 260 is abnormal, the step 320 is performed.

Then, as shown in step 316, if the first network connection 260 is normal, the processing unit 228 executes the program to further judge whether the IAD 220 successfully registers through the first network connection 260 or not. If the IAD 220 does not successfully register through the first network connection 260, the step 320 is performed.

Finally, as shown in step 318, if the IAD 220 successfully registers through the first network connection 260, it represents that the IAD 220 can normally transmit the voice packet through the first network connection 260, and the IAD 220 does not have to enter the backup mode.

FIG. 5 is a detailed flow chart showing the step 320. Referring to FIG. 5, the step 320 includes the following steps. First, as shown in step 322, a second default time, such as 60 seconds, is waited for.

Next, as shown in step 324, after the second default time has elapsed, the processing unit 228 executes the program to judge whether the IAD 220 successfully registers through the second network connection 270 or not. If the IAD 220 successfully registers through the second network connection 270, it represents that the IAD 220 can normally transmit the voice packet through the second network connection 270. Inversely, if the IAD 220 does not successfully register through the second network connection 270, the step 322 is performed.

Finally, as shown in step 326, after the IAD 220 successfully registers through the second network connection 270, the IAD 220 can enter the backup mode to timely transmit the voice packet through the second network connection 270.

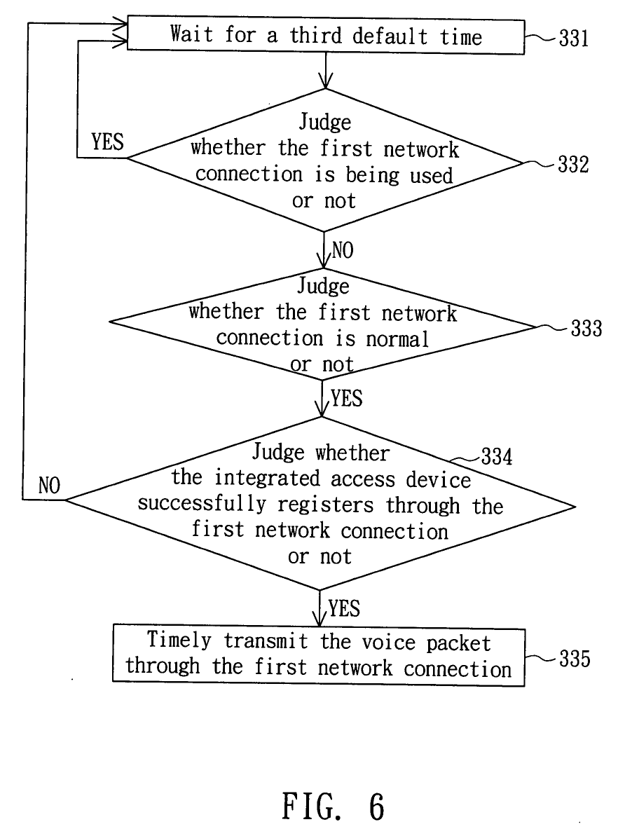

FIG. 6 is a detailed flow chart showing the step 330. Referring to FIG. 6, the step 330 includes the following steps. First, as shown in step 331, a third default time, such as 180 second, is waited for.

Next, as shown in step 332, after the third default time has elapsed, the processing unit 228 executes the program to judge whether the first network connection 260 is being used or not. If the first network connection 260 is being used, the step 331 is repeated.

Then, as shown in step 333, if the first network connection 260 is not being used, the processing unit 228 executes the program to further judge whether the first network connection 260 is normal or not.

Next, as shown in step 334, if the first network connection 260 is normal, the processing unit 228 executes the program to further judge whether the IAD 220 successfully registers through the first network connection 260. If the IAD 220 does not successfully register through the first network connection 260, the step 331 is repeated.

Then, as shown in step 335, if the IAD 220 successfully registers through the first network connection 260, the IAD 220 timely recovers to transmit the voice packet through the first network connection 260.

In the integrated access device, the VOIP system and the backup method thereof according to the embodiment of the invention, the voice packet is transmitted through the first network connection 260 when the first network connection is normal. Because the first network connection 260 is dedicated to the transmission of the voice packet, the delay time of the voice packet transmission can be shortened.

Furthermore, when the voice packet cannot be transmitted through the first network connection, the voice packet is timely transmitted through the second network connection. Because the second network connection timely serves as the backup line of the first network connection, it is possible to effectively prevent the talking from being interrupted or prevent the VOIP phone call from being made unsmoothly, thereby providing the better talking quality for the user.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A voice over Internet protocol (VOIP) system, comprising:
a first remote server;
a second remote server; and
an integrated access device (IAD), which comprises:
a first Internet protocol interface, wherein a first network connection is built between the first Internet protocol interface and the first remote server; and
a second Internet protocol interface, wherein a second network connection is built between the second remote server and the second Internet protocol interface;
a memory unit for storing a program; and
a processing unit for executing the program to judge whether the integrated access device can transmit a voice packet through the first network connection or not, wherein when the integrated access device cannot transmit the voice packet through the first network connection, the voice packet is timely transmitted through the second network connection.

2. The system according to claim 1, wherein the processing unit executes the program to judge whether the first network connection is normal or not, and the voice packet is timely transmitted through the second network connection when the first network connection is not normal.

3. The system according to claim 2, wherein if the first network connection is normal, the processing unit executes the program to judge whether the integrated access device successfully registers through the first network connection or not, and the voice packet is timely transmitted through the second network connection when the integrated access device does not successfully register.

4. The system according to claim 1, wherein the processing unit executes the program to judge whether the integrated access device can recovers to transmit the voice packet through the first network connection or not, and the voice packet is timely transmitted through the first network connection if the integrated access device can recover to transmit the voice packet through the first network connection.

5. The system according to claim 4, wherein the processing unit executes the program to judge whether the first network connection is being used or not, and if the first network connection is not being used, the voice packet is timely transmitted through the first network connection when the first network connection is normal and the integrated access device successfully registers the first network connection.

6. The system according to claim 1, wherein the second remote server may be a MS-Broadband Remote Access Server (BRAS) and the first remote server may be a Voice-Broadband Remote Access Server (BRAS).

7. The system according to claim 1, wherein the second Internet protocol interface may be a multi-service Internet protocol interface and the first network connection may be a voice Internet protocol interface.

8. A backup method for a voice over Internet protocol (VOIP) system, the VOIP system comprising a first remote server, a second remote server and an integrated access device (IAD), the integrated access device comprising a first Internet protocol interface and a second Internet protocol interface, a first network connection being built between the first Internet protocol interface and the first remote server, a second network connection being built between the second Internet protocol interface and the second remote server, the backup method comprising the steps of:
(a) judging whether the integrated access device can transmit a voice packet through the first network connection or not;
(b) enabling the integrated access device to enter a backup mode so that the voice packet is timely transmitted through the second network connection if the integrated access device cannot transmit the voice packet through the first network connection;
(c) judging whether the integrated access device can recover to transmit the voice packet through the first network connection or not; and
(d) timely transmitting the voice packet through the first network connection if the integrated access device can recover to transmit the voice packet through the first network connection.

9. The method according to claim 8, wherein the step (a) comprises:
(a1) waiting for a first default time; and
(a2) judging whether the first network connection is normal or not after the first default time has elapsed; and
(a3) judging whether the integrated access device successfully registers through the first network connection or not if the first network connection is normal.

10. The method according to claim 8, wherein the step (b) comprises:
(b1) waiting for a second default time;
(b2) judging whether the integrated access device successfully registers through the second network connection or not after the second default time has elapsed; and
(b3) timely transmitting the voice packet through the second network connection if the integrated access device successfully registers through the second network connection.

11. The method according to claim 8, wherein the step (c) comprises:
(c1) waiting for a third default time;
(c2) judging whether the first network connection is being used or not after the third default time has elapsed;
(c3) judging whether the first network connection is normal or not if the first network connection is not being used;
(c4) judging whether the integrated access device successfully registers through the first network connection or not if the first network connection is normal; and
(c5) timely recovering to transmit the voice packet through the first network connection if the integrated access device successfully registers through the first network connection.

12. The method according to claim 11, wherein the step (c1) is repeated if the first network connection is being used in the step (c2).

13. The method according to claim 11, wherein the step (c1) is repeated if the integrated access device does not successfully register through the first network connection in the step (c3).
